(19) United States
(12) Patent Application Publication
(10) Pub. No.: US 2007/0252782 A1
(43) Pub. Date: Nov. 1, 2007

(54) IMAGE DISPLAY APPARATUS

(75) Inventor: Hideaki YUI, Machida-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/614,441

(22) Filed: Dec. 21, 2006

(30) Foreign Application Priority Data
Dec. 28, 2005 (JP) 2005-377893
Dec. 6, 2006 (JP) 2006-329262

(51) Int. Cl. G09G 3/20

(52) U.S. Cl. 345/58

(57) ABSTRACT

An image display apparatus of the present invention comprises: a plurality of pixels for displaying an image on a screen; and a drive unit for outputting a drive signal for driving the plurality of pixels by interlace, the drive unit including a correction value outputting circuit for outputting a correction value for correction for suppressing a deterioration of image quality due to crosstalk and an outputting unit for outputting the drive signal corrected by the correction value, wherein the correction value is calculated based on pixel data corresponding to at least one pixel proximate to a pixel which is objective for correction and the pixel data used for the calculation includes pixel data in a field in which the pixel which is objective for the correction is driven and pixel data in a field in which the pixel which is an objective for the correction is not driven.

### BACKGROUND OF THE INVENTION

1. Field of the Invention

The present invention relates to an image display apparatus.

2. Description of the Related Art

U.S. Pat. No. 6,307,327 has disclosed a method of controlling the visibility of spacer in a field emission display. This publication describes a pixel data correction method which defines a first region proximate to the spacer and a second region not proximate to the spacer and corrects pixel data to be sent to the first region to render the space invisible to a viewer.

Japanese Patent Application Laid-Open (JP-A) No. 2005-31636 has disclosed a correction method of correcting data corresponding to an attention pixel based on data corresponding to pixel proximate to the attention pixel in an image display apparatus.

### SUMMARY OF THE INVENTION

Crosstalk can occur between pixels in an image display apparatus in which matrix-drives a plurality of pixels.

The crosstalk mentioned here is defined as an influence which the light quantity outputted from a predetermined pixel receives by a drive of other pixels.

For example, an example that the pixel comprises an electron=emitting device and a light-emitting region for emitting light when irradiated with electron emitted from the electron-emitting device will be picked up.

In this structure, electron emitted from the electron-emitting device of a certain pixel may impinge upon the light-emitting region of other pixel. As a consequence, the light quantity outputted by the light emitting region of other pixel increases.

In an image display apparatus using a pixel having an electrode for applying electric field to liquid crystal, electric field generated by an electrode of a certain pixel can affect other pixels. As a consequence, the light quantity (amount of transmitted light or amount of reflected light) outputted by other pixel is affected.

The crosstalk affects the quality of a displayed image. When the crosstalk is generated, the light quantity of a pixel deflects from a predetermined light quantity. Further, when the crosstalk is generated between pixels of different colors, chrome saturation is deteriorated. When the crosstalk is generated unevenly in a screen, unevenness of brightness occurs in the screen. These deteriorate the image quality.

The deterioration of the image quality due to the crosstalk can be reduced by correction.

For example, a difference between the quality of an actually obtained light and the quality of necessary light (light quantity specified by input signal) can be reduced by correcting to reduce the light quantity outputted by the pixel whose outputted light quantity is increased by the crosstalk. If the crosstalk is generated between pixels of different colors, deterioration of chrome saturation can be suppressed by this correction. Further, unevenness of brightness when the amount of the crosstalk is uneven in the screen can be reduced by this correction.

If the light quantity increased by the crosstalk differs among pixels, the unevenness of brightness can be reduced by correcting so as to increase the light quantity of a pixel whose light quantity increased by the crosstalk is small.

Display conditions for plural kinds of images have been known.

For example, interlace display and progressive display have been well known. Further, 60 Hz display (image display in which refresh start is 60 Hz or images are displayed 60 times per second (a display of image may be by interlace display or by progressive display)) and a display at a higher refresh rate have been known also.

In an image display apparatus which displays by matrix-driving plural pixels, a plurality of pixels are interlace driven so as to achieve interlace display. To achieve progressive display, a plurality of pixels are progressively driven.

An object of the present invention is to achieve a structure for executing a correction for suppressing deterioration of image quality due to crosstalk preferably upon interlace driving.

Another object of the present invention is to achieve a structure for executing a correction for suppressing deterioration of image quality due to the crosstalk corresponding to a display condition in which the frequency of image displays a unit time differs.

To achieve above-mentioned object, the present invention provides an image display apparatus comprising: a plurality of pixels for displaying an image on a screen; and a drive unit for outputting a drive signal for driving the plurality of pixels by interlace, the drive unit including a correction value outputting circuit for outputting a correction value for correction for suppressing a deterioration of image quality due to crosstalk and an outputting unit for outputting the drive signal corrected by the correction value, wherein the correction value is calculated based on pixel data corresponding to at least one pixel proximate to a pixel which is an objective for correction and the pixel data used for the calculation includes pixel data in a field in which the pixel which is the objective for the correction is driven and pixel data in a field in which the pixel which is the objective for the correction is not driven.

In addition, the present invention provides an image display apparatus comprising: a plurality of pixels for displaying an image on a screen; and a drive unit for outputting a drive signal for driving the plurality of pixels by interlace, the drive unit including a correction value outputting circuit for outputting a correction value for correction for suppressing a deterioration of image quality due to crosstalk and an outputting unit for outputting the drive signal corrected by the correction value, the correction value outputted circuit including a memory for storing n pixel data corresponding to n pixels proximate to the pixel which is objective for correction and a conversion circuit for converting n pixel data stored in the memory to m (m is an integer number larger than n) pixel data, wherein the correction value is generated based on an output of the conversion circuit.

Furthermore, the present invention provides an image display apparatus comprising: a plurality of pixels for displaying an image on a screen; and a drive unit for outputting a drive signal for driving the plurality of pixels by interlace, the drive unit including a correction value outputting circuit for outputting a correction value for correction for suppressing a deterioration of image quality due to crosstalk and an outputting unit for outputting the drive signal corrected by the correction value, wherein the correction value outputting circuit generates the correction value by arithmetic operation using pixel data corresponding to pixel proximate to a pixel which is objective for correction and executes different arithmetic operation between when the frequency of image displays per a unit time by the plural pixels is a first value and when it is a second value larger than the first value.

### BRIEF DESCRIPTION OF THE DRAWINGS

FIG. 1 is a block diagram of a halation correcting unit when interlace is driven according to a first and second embodiment;

FIG. 2 is a block diagram of a halation correcting unit when interlace is driven according to a third embodiment;

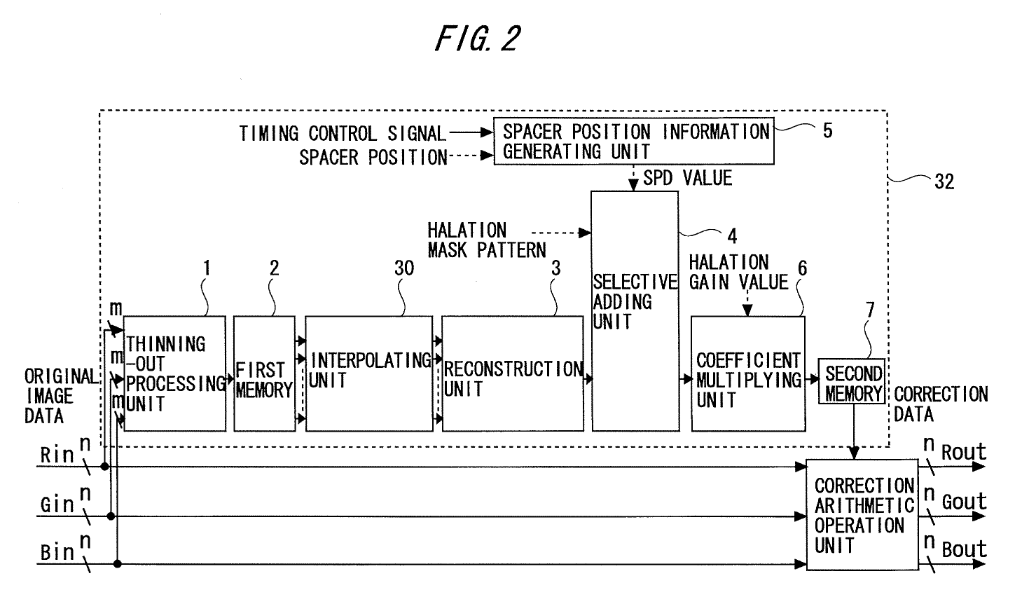

FIG. 3 is a block diagram of a halation correcting unit when progressive is driven;

FIG. 4 is a block diagram of an image display apparatus;

FIGS. 5A and 5B are explanatory diagrams of halation generation mechanism not in the vicinity of the spacer;

FIGS. 6A and 6B are explanatory diagrams of halation generation mechanism in the vicinity of the spacer;

FIG. 7 is a halation mask pattern diagram when progressive is driven;

FIG. 8 is a corresponding diagram of pixel region which shields reflecting electrons corresponding to a distance between an attention pixel and spacer when progressive is driven;

FIGS. 9A and 9B are image diagrams of halation correction according to shielding amount adding method;

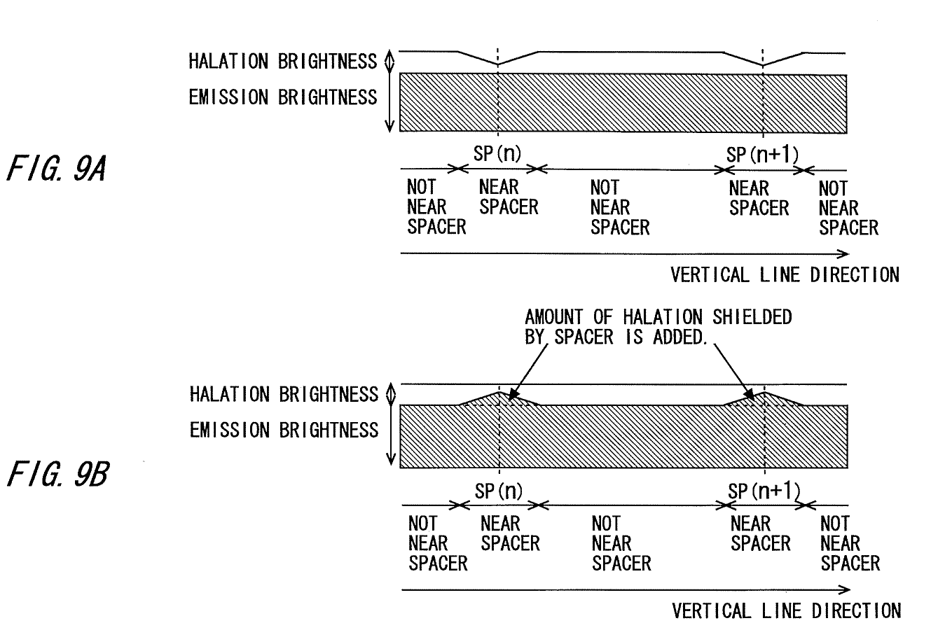

FIGS. 10A and 10B are halation mask pattern diagrams when interlace is driven;

FIG. 11 is a corresponding diagram of a pixel region which shields reflecting electrons corresponding to a distance between the attention pixel and spacer when interlace is driven;

FIG. 12 is a conceptual diagram showing timing of halation correction processing when interlace is driven according to the second embodiment;

FIG. 13 is a diagram showing comparison between a range of reference pixel when progressive is driven and a range of reference pixel when interlace is driven;

FIG. 14 is a conceptual diagram showing pixel interpolation method of non-driven line by linear interpolation method according to a third embodiment; and

FIG. 15 is a conceptual diagram showing timing of halation correction processing when interlace is driven according to the third embodiment.

### DESCRIPTION OF THE EMBODIMENTS

Hereinafter, the preferred embodiments of the present invention will be described in detail with reference to the accompanying drawings.

The present invention can be applied to a display apparatus using a surface conduction type emission device, a field emission type display apparatus (FED), a plasma display apparatus (PDP), organic EL display apparatus and the like. Because the present invention can reduce adverse effect of crosstalk to visibility appropriately, it can be applied to a variety of display apparatuses which generate crosstalk. Because in an electron beam display apparatus such as the display apparatus using the surface conduction type emission device, FED, halation light emission can be generated in surrounding pixels due to brightness of a luminescent spot emitting light itself, the electron beam display apparatus is a preferred embodiment to which the present invention is applied. Further, because halation (crosstalk) can be generated in surrounding pixels in the plasma display apparatus if there exists no partition wall between discharge cells or if the partition wall structure is larger than pixel unit, the plasma display apparatus is a preferred embodiment to which the present invention is applied. Brightness is determined by the potential of retentive capacity in a liquid display apparatus or organic EL and the potential of pixel can affect the potential of pixel proximate (crosstalk). Particularly, this is remarkable as pixel pitch decreases (turned highly fine). The present invention can be applied preferably to an image display apparatus in which crosstalk can be generated between proximate devices. Hereinafter, the structure of a display apparatus using the surface conduction emission device as an image display apparatus will be described as a particularly preferred embodiment.

### First Embodiment

The first embodiment of the present invention will be described. This embodiment is intended for correcting unevenness of brightness due to crosstalk when interlace display is carried out.

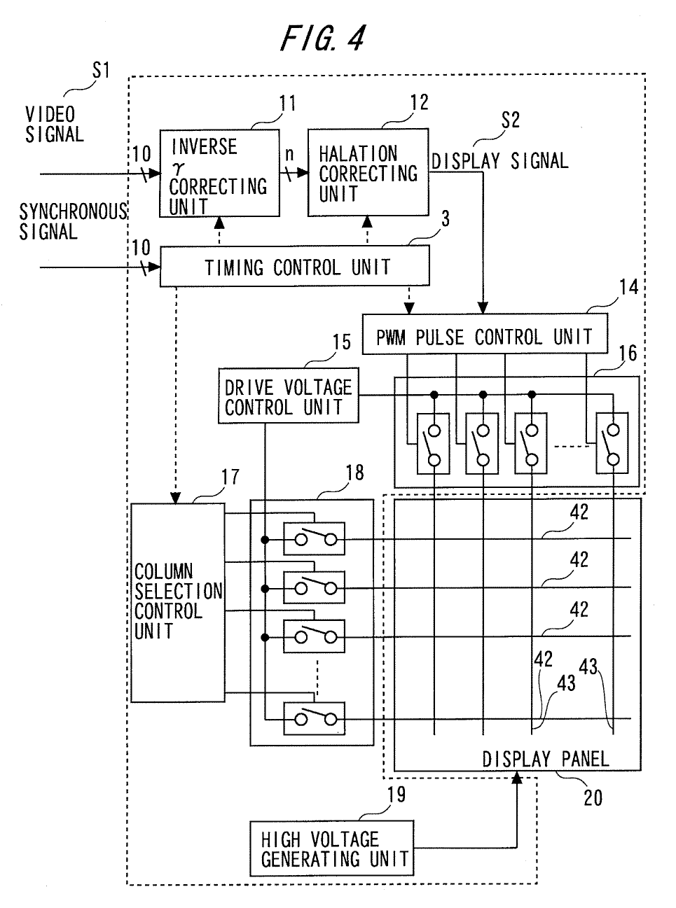

FIG. 4 shows the structure of an image display apparatus of the embodiment. Reference numeral 20 denotes a display panel. The display panel 20 includes a multi-electron source comprised of a plurality of electron emitting devices (for example, cold cathode device; arranged on a substrate such that they oppose to each other in a thin vacuum container and an image forming member (for example, fluorescent body) which forms an image by irradiating electrons. The fluorescent body is formed on a face plate glass substrate which constitutes a screen. The electron emitting devices are arranged in a simple matrix with row oriented wiring electrode 42 (row wiring) and column oriented wiring electrode 43 (column wiring) and an electron is emitted from a device selected by column/row electrode bias. Light emission is obtained by accelerating electron under high voltage to collide against fluorescent body. The fluorescent body is used as a light emission region here. A pixel is constituted of an electron emitting device and a light emission region corresponding to that electron-emitting device. Electron from an electron-emitting device of a certain pixel makes mainly a light emission region of that pixel emit light.

In the meantime, a pixel can be constituted by combining a plurality of pixels corresponding to different colors. The present invention can be applied to not only a case where a pixel corresponds to a color but also a case where a pixel is a combination of pixels corresponding to a plurality of colors (for example, a structure which handles a combination of red pixel, green pixel and blue pixel as a single pixel).

In this embodiment, the surface conduction type emission device is used as an electron-emitting device. The structure and manufacturing method of the display panel using the surface conduction type emission device has been disclosed in the JP-A No. 2000-250463.

A drive unit 41 outputs a signal for driving pixels possessed by a display panel 20. The drive unit 41 comprises a signal processing unit 10, a PWM pulse control unit 14, a drive voltage control unit 15, a column wiring switch unit 16, a row selection control unit 17, a row wiring switch unit 18 and a high voltage generating unit 19. When a plurality of pixels on the display panel 20 are interlace-driven, a selection signal for selecting the row wire every other successively is outputted from the row wiring switch unit 18. Upon progressive drive, selection signals for selecting a row wire without placing not-selected row wire midway successively are outputted. A drive signal for driving a pixel connected to a selected row wire is outputted to the column wiring synchronously with selection of the row wiring. An operation from input of a video signal to the display panel 20 to display thereon will be described. A signal S1 is an inputted video signal. The inputted video signal is a set of pixel data which are data for specifying the light quantity of each pixel. Pixel data corresponding to each different pixel is inputted successively. The signal processing unit 10 executes a preferable signal processing on the input video signal S1 and outputs a display signal S2.

Reference numeral 11 denotes an inverse γ correcting unit. Generally, the input video signal S1 is subjected to nonlinear conversion (λ=0.45) called gamma conversion matching CRT display input—light emission characteristic (λ=2.2) for transmission and recording. When the video signal is displayed on a display device which is linear in input-light emission characteristic such as the display apparatus using the surface conduction type emission device, FED, PDP, a preferred display is enabled by executing the inverse gamma conversion (λ=2.2) upon the input signal.

The input signal S1 is often inputted to the inverse λ correcting unit 11 by 8 bits-10 bits for each color. In order to avoid collapse of a low tone unit due to nonlinear inverse gamma conversion, preferably, the conversion is carried out in a data width of 10bits-16 bits corresponding to display performance of the display unit. Although the inverse λ correction is mentioned here as an example of signal processing other than correction relating to crosstalk, a variety of signal processings can be carried out as required for other purposes than the inverse λ correction.

Output data of the inverse λ correcting unit 11 is converted so that brightness of the display panel and data are in a linear relationship. The output data is inputted to the halation correcting unit 12. The halation correcting unit 12 has a correction value output circuit. The halation correcting unit 12 will be described in detail later.

A display signal S2 for displaying a preferred video image on the display panel 20 is outputted from the halation correcting unit 12. The display signal S2 is a corrected signal because in this embodiment, the halation correcting unit 12 includes a circuit for executing a calculation using a correction value generated by the correction value output circuit and a signal which is an objective for correction. The timing control unit 13 generates and outputs a variety of timing signals for operation of each block based on a synchronous signal transferred together with the input video signal S1.

The PWM pulse control unit 14 converts the display signal S2 to a drive signal suitable for the display panel 20 each horizontal cycle (each row selection period) (pulse width modulation (PWM) in this embodiment). The drive voltage control unit 15 controls a voltage for driving devices arranged on the display panel 20. The row wiring switch unit 16 is constituted of a switch means such as a transistor and applies an output form the drive voltage control unit 15 to a panel column electrode only in a period of PWM pulse outputted from the PWM pulse control unit 14 each horizontal cycle (each row selection period). Consequently, a corrected drive signal is supplied to the display panel 20. The row selection control unit 17 generates a row selection pulse for driving devices on the display panel 20. The row wiring switch unit 18 constituted of a switch means such as a transistor and outputs an output of the drive voltage control unit 15 to the display panel 20 corresponding to a row selection pulse outputted from the row selection control unit 17. The row wiring switch unit 16 and the column wiring switch unit 18 are output units for outputting a drive signal to a wire to which a pixel is connected. The high voltage generating unit 19 generates an accelerating voltage for accelerating an electron emitted from the electron emitting device disposed on the display panel 20 in order to collide it against a fluorescent body. In the above structure, the display panel 20 is driven so that a video image is displayed. Next, “halation” which is one aspect of the crosstalk will be described.

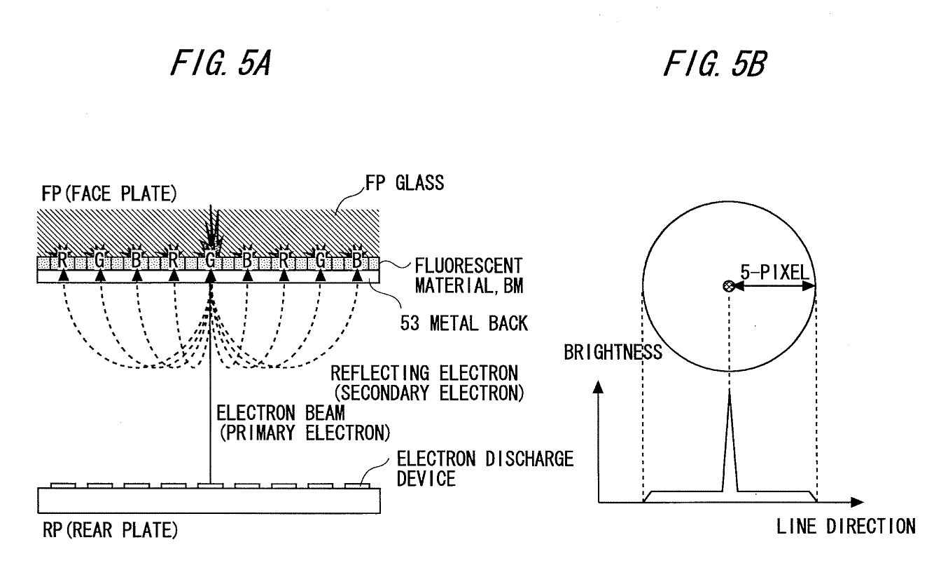

FIG. 5A shows an image display apparatus which uses an electron emitting device 51 formed on a rear plate and a luminescent body 52 (red, blue, green fluorescent bodies in this example, each which constitutes a light emission region) disposed on a face plate with an interval to the electron emitting device and makes the luminescent body emit light when electron beam emitted from the electron emitting device is irradiated to the luminescent body. A metal back 53 is an anode on which potential for accelerating electron is applied. This inventor has paid attention to that crosstalk occurs between pixels in such an image display apparatus. When a certain pixel is driven, the light quantity outputted by a pixel proximate thereto deflects from a desired value. Consequently, color reproducibility becomes different from a desired state, which is a problem to be solved. If taking a specific example, when it is intended to obtain blue light emission by irradiating electron only to blue fluorescent body, a light emission state not in pure blue, that is, in which slightly different color namely light emission of green and red is mixed is produced, thereby producing a light emission state not good in chrome saturation.

As a result of accumulated researches, the inventor has confirmed that a following state occurs as well as a corresponding light emitting region emits light from its luminescent spot when electron emitted from the electron emitting device impinges upon a fluorescent body corresponding to the electron emitting device. That is, it has been found that impinging of electron (reflecting electron of secondary electron) to a proximate light emitting region (including a light emitting region of different color) proximate (including adjacent region) is generated by reflection of emitted electron in a corresponding light emitting region so that surrounding light emitting regions are made to emit light. If a light emitting region of a color different from a color of an attention light emission region is contained in a light emitting region which emits light by drive of an electron emitting device corresponding to the attention light emitting region, the light emitting region of the different color being proximate to the attention light emitting region, chrome saturation is deteriorated. A phenomenon that a certain display device (pixel) emits light is being affected by drive of other proximate display device (pixel) is called “halation”. This is an example of the crosstalk generated between proximate pixels.

It has been found that when a certain fluorescent body is irradiated with electrons as shown in FIG. 5B in the display unit (structure shown in a following embodiment) using the surface conduction type emission device, circular light emission (if expressed with brightness as the light quantity emission, distributed in a cylindrical form around a luminescent spot) occurs around that pixel. If influences given by other pixels upon the attention pixel can be evaluated, correction processing for suppressing reduction in image quality by the crosstalk can be carried out. Because the influences by other pixels upon the attention pixel are determined by driving condition of the other pixels, appropriate correction processing can be executed by generating a correction value using data having correlation with the driving condition of the other pixels. As the data having correlation with the driving condition of pixel, pixel data for specifying the light quantity of that pixel may be used. When the crosstalk between arbitrary two pixels is evaluated, it is possible to neglect the crosstalk therebetween if those two pixels are sufficiently apart from each other. Therefore, the appropriate correction processing can be carried out by generating a correction value using the pixel data of a pixel located at a position where it can affect the attention pixel. The amount by which the light quantity of the attention pixel is affected by driving of a certain pixel can be evaluated with a function which uses the pixel data of the pixel as a variable. As that function, it is possible to adopt a function obtained by multiplying the pixel data of the pixel with a coefficient which indicates in what ratio the crosstalk is generated. The pixel for generating the crosstalk such as halation in the attention pixel is not limited to one. If influence on the attention pixel from surrounding plural pixels are evaluated, the plural pixel data are referred to as a variable. When the plural pixel data are referred, filter processing may be adopted preferably. For example, if the radius of the circular region which halation reaches is N pixels, 2N+1 tap filter may be adopted preferably as a pixel reference range for halation correction range which will be described in detail later.

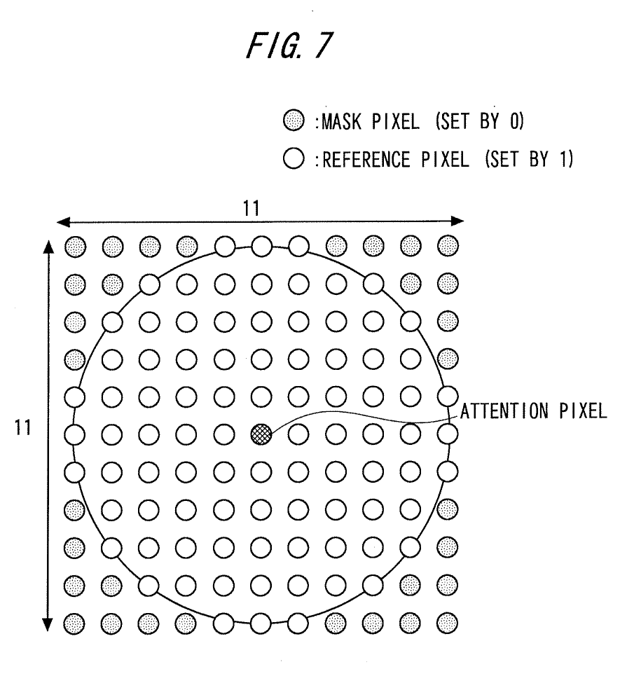

It has been found that there is not problem if the radius of a range which the aforementioned halation reaches is automatically determined by an interval between the face plate in which the fluorescent body is disposed and the rear plate in which an electrode source is disposed, pixel size and the like. Thus, if the interval between the face plate and the rear plate is determined, the amount of filter taps is automatically determined. Because in this embodiment, N is five pixels, a 11-tap filter is used. That is, it is apparent that data of 11 pixels×11 lines as shown in FIG. 7 may be referred in order to consider the degree of influence of halation. That is, data corresponding to pixels required to be referred for correction of the crosstalk, arranged around the attention pixel located as a reference position is referred. The pixels are located within a circle of a diameter of 1× pixel pitch around the attention pixel and a distance between each of these pixels and the attention pixel satisfies a condition that driving of each pixel increases brightness of the attention pixel. The reference range is a range including these pixels. In the meantime, the range including the pixels required to be referred may be set appropriately depending on the structure of the display unit.

The radius of a region, which the halation reaches, is a static parameter obtained form the physical structure (interval between the face plate and rear plate, pixel size) of the display panel. Thus, is an identical correcting circuit is made to correspond to display panels of plural different types, the halation mask pattern of FIG. 7 may be set to be changeable as a variable parameter.

Generation of the crosstalk such as halation can affect the image quality of itself. The reason is that the light quantity of a pixel deflects from a predetermined light quantity by the crosstalk. If the crosstalk occurs between pixels of different colors, chrome saturation deteriorations. An influence made on the image quality thereby is a first problem. If the way in which the crosstalk generated differs locally within a screen, the image quality is more largely affected. For example, when inputted pixel data requires the same light quantity to each pixel within the screen, if the light quantity, which increases by the crosstalk, is identical among respective pixels, a difference in the light quantity never occurs among the respective pixels. However, when the inputted pixel data requires the same light quantity to the respective pixels within the screen, if the increase in the light quantity by the crosstalk is large in some pixel while the increase in the light quantity by the crosstalk is relatively small in other pixel, a difference in the light quantity occurs among the respective pixels. This difference in light quantity generates a bright unit and a dark unit. Unevenness of the brightness can be evaluated by measurement of the brightness with a luminescent meter. An influence of the unevenness of brightness upon the image quality is a second problem.

There can exist an image display apparatus in which the crosstalk occurs frequently in part of a screen thereof (first region) while the crosstalk unlikely occurs as compared with the first region. The amount of the crosstalk depends on the driving condition of pixel which can generate the crosstalk to the attention pixel as described above and deterioration of the image quality becomes apparent if the amount of the crosstalk differs between the regions despite an identical driving condition.

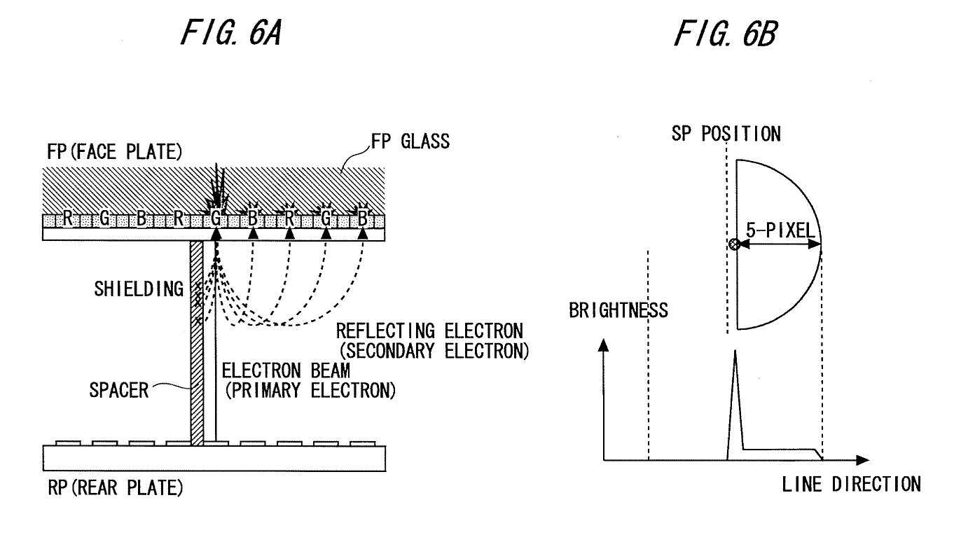

FIG. 5B shows a case where no shielding member such as a spacer exists on a reflection trajectory of reflecting electron (not in the vicinity of the spacer). On the other hand, if a shielding member such as the spacer exists (near the spacer), the reflecting electron (secondary electron) is shielded by the spacer as shown in FIG. 6A, so that the intensity of the halation is reduced. Space is provided between the electron emitting device and the light emitting region. This space is kept at a lower pressure than external atmosphere of the display panel. The spacer is a member for maintaining this space. It has been made apparent that an influence range of halation when electron beam (primary electron) is emitted from an electron emitting device most proximate to the spacer turns to semi-circular light emission as shown in FIG. 6B. Although FIGS. 5, 6 shown influences on surrounding pixels from the attention pixel, an influence from the surrounding pixels to the attention pixel occurs in the same way. Assuming that a pixel located in the center is the attention pixel in the region shown in FIG. 5, an influence from pixels within a distance of five pixels apart in the surrounding is generated to the attention pixel. On the other hand, in the range shown in FIG. 6, only pixels located on the same side as the attention pixel with respect to the spacer of pixels arranged within the distance of five pixels apart around the attention pixel can affect the attention pixel. Here, the spacer functions as a member which inhibits the crosstalk.

A plurality of long spacers extending horizontally for supporting the face plate and the rear plate are mounted every several tens lines on the display panel used in this embodiment. It is preferable to provide an interval by an amount of 15 lines (15 pixels) or more because there exists a problem about cost if the spacer is disposed in each line. Spacers of a variety of shapes may be used. The spacers are disposed along a horizontal line within the display panel and a sheet-like spacer having a length extending from near an end in a horizontal direction of the display panel to near the other end thereof is adopted here.

It has been found that when the entire surface is lit in an identical color under this structure, a difference in the amount of halation occurs due to the above-described halation between different regions, namely a region in the vicinity of a spacer and a region not in the vicinity of the spacer. It has been confirmed that a particular problem, that is, unevenness of spacer that color purity in the vicinity of the spacer is changed due to a difference in the amount of halation occurs. The degree of spacer unevenness differs depending on a lighting pattern of a displayed image. For example, if the entire surface is lit in blue, brightness of halation is added to the brightness of light emission. This brightness of halation is referred to as “amount of change given by drive of a display device having other light emitting region than a predetermined light emitting region to light emission of the predetermined light emitting region”. Because in the region in the vicinity of the spacer, the amount of shielding of reflecting electron changes by stages depending on a distance from the spacer, a gradual wedge-like change in color purity having a width of about 10 lines is recognized visually. A wedge-like deterioration of the brightness means “an amount reduced by the spacer of the brightness of halation”.

Unevenness of brightness occurs due to uneven generation of crosstalk between proximate pixels within the screen. In case of multi-color, the unevenness of brightness can be recognized as unevenness of color.

The unevenness of brightness, which occurs due to the crosstalks generated unevenly between proximate pixels, is remarkable when input pixel data corresponding to all pixels are pixel data of identical value (when an image of solid color is displayed. That is, if it is intended to display a screen of solid color, the crosstalk is generated unevenly within the screen so that unevenness of generated brightness (unevenness of color) is conceivable. An image displayed on the image display apparatus is not limited to an image of solid color and although it is not necessary to distinguish the image of solid color from other images, it is preferable that the correction of the present invention is carried out at least on an image of solid color.

As a method for suppressing deterioration of image quality by the crosstalk such as halation, two major methods are available. One of them concerns a structure for, if the light quantity of the attention pixel differs by Δ L from a desired value (light quantity specified by pixel data to be inputted), executing correction processing in order to obtain a drive signal subjected to correction by the amount of the Δ L. For example, if the light quantity of the attention pixel is increased by Δ L from a desired value due to an influence by driving of other pixel, it is desirable that the drive signal of the attention pixel is turned to a signal subjected to correction which can obtain a light quantity smaller by Δ L than the desired value. The desired light quantity can be obtained when a decrease in the light quantity due to correction kills an increase in the light quantity due to the crosstalk.

A display under an image quality near a configuration in which no crosstalk is generated can be attained by this correction. With these procedures, the above-described first problem is solved.

This embodiment adopts an embodiment for solving the second problem of the above-described first problem and second problem. More specifically, in an image display apparatus having a region which is affected by suppression of the crosstalk by use of a member for suppressing the crosstalk, that region is corrected to a state in which the crosstalk is not suppressed or a state similar to the state in which the crosstalk is not suppressed. Although this is not intended to correct a deflection between a desired light quantity generated by the crosstalk and an actually obtained light quantity, this correction also aims at suppressing deterioration of the image quality due to the crosstalk.

Unevenness of bright which occurs when the amount of deflection of the light quantity of a first pixel located in a first region (for example, region proximate to the spacer) from a desired value by being affected by driving of other pixel in smaller than the amount of deflection of the light quantity of the second pixel located in the second region (region more apart from the spacer than a region proximate to the spacer) from a desired value by being affected by driving of other pixels; and the unevenness of brightness which appears clearly when the inputted pixel data requires an identical light quantity to the first pixel and the second pixel result from deterioration of the image quality due to the crosstalk. Then, correction of bringing the light quantity of the first pixel to the light quantity of the second pixel (including adjusting the light quantities of the first pixel and second pixel to the same level) aims at suppressing deterioration of the image quality by the crosstalk. Correction for suppressing deterioration of the image quality due to local existence of a member suppressing the crosstalk can be carried out by evaluating the amount of suppression of the crosstalk with that member. Hereinafter, the structure thereof will be described in detail.

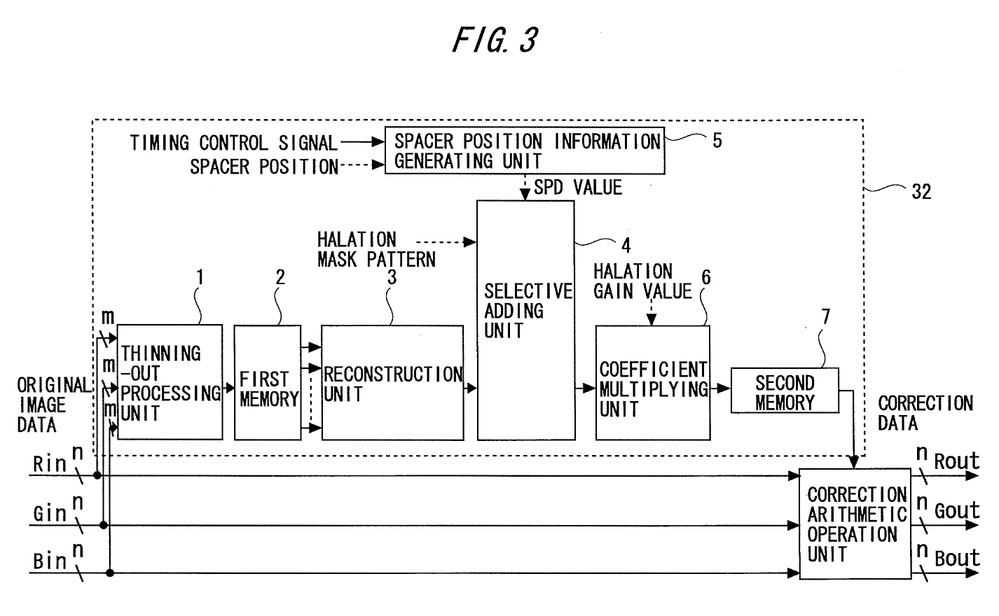

A specific example of an image display apparatus and a correction method of drive signal will be described with reference to FIG. 3. Prior to description about correction when interlace is driven, correction when the progressive is driven will be described. FIG. 3 shows a case where the display panel is driven by progressive driving (frame rate: 60 Hz).

The halation correcting circuit shown in FIG. 3 comprises a correction value output circuit 31 and a correction arithmetic operation unit 8 which is an arithmetic operation circuit for correcting pixel data using a correction value outputted by the correction value output circuit 31. Because pixel data outputted from the correction arithmetic operation unit 8 is corrected pixel data (display signal S2), a drive signal generated by the corrected pixel data becomes a corrected drive signal.

Original image data (pixel data prior to correction) to be inputted into the halation correcting unit 12 is an output from the inverse λ correcting unit 11. Assuming that this original image data is inputted by n bit for each of RGB, the configuration of the display panel used in this embodiment requires a 11×11 tap filter and for executing an arithmetic operation, at least 11 line memories at least are required. A line memory amount M necessary for the correction in this example is expressed in a following expression.

When high tone display is carried out under the condition when the line memory capacity M=horizontal pixel number×n bit×RGB×11 lines, amount of horizontal pixels =1920 pixels, n=16 bits, correction line memory capacity M expands to a tremendously large amount of 1920×16×3×11=1014 Kbits. It is understood easily that when an arithmetic operation memory with such a amount is mounted on an LSI for signal processing as it is, a required die size expands thereby increasing chip cost largely.

Thus, the thinning-out processing unit 1 reduces original data and transfers it to the first memory 2 in order to reduce the line memory capacity M. In this embodiment, two methods are adopted to reduce the original data.

A first one of them is to reduce the amount of reference bits by referring to only upper m bits (n>m) of the original data (n bit). Here, m value is so determined that it is included in an error ratio which never reduces arithmetic operation accuracy of the halation correction. It has been made apparent that the amount of bits can be reduced to m=8 bits through an experiment if an output of the inverse λ correcting unit 11 is n=12 bits-16 bits. This is because that the amount of halation is calculated by multiplying total lighting amount of the reference pixel with a predetermined minute coefficient, an influence upon a calculation result is small even if a value of lower bit of the original data is neglected. That is, because resolution of the reference pixel is determined depending on this minute coefficient, the lower bit of the original data can be neglected.

A second one is a method of approximating the above-mentioned influence range of halation as a pixel unit in which plural pixels corresponding to different colors are combined not as a RGB sub-pixel (pixel of single color) unit. More specifically, the quantities of lighting of each of RGB sub-pixels are summed up with pixel (m+2 bits)=R (m bit)+G (m bit)+B (m bit) and this sum is made representative of the total lighting amount of the pixels.

According to the two methods for reducing the original data, the line memory capacity is line memory capacity M′=amount of horizontal pixel×m bits×((m+2)/3 m) RGB×11 line=(m/n)×((m+2)/3 m)×M=(8/16)×(10/24)×M=0.21×M. The capacity of the first memory 2 can be reduced to 213 Kbit (21% 1024 Kbit) without lowering the correction accuracy. Such thinning-out processing may be carried out as required and no thinning-out processing needs to be carried out if a sufficient capacity is secured as that of the first memory.

When progressive is driven, output from the thinning-out processing unit 1 is written successively by the unit of a line into the first memory 2 constituted of 11 line memories. Written pixel data (pixel data subjected to thinning-out processing) is memorized in the first memory 2. At the time when data of 11 line (pixel data subjected to thinning-out processing) is stored, data of 11 pixels×11 lines are read out form the 11 line memories for reference of the arithmetic operation. Because the first memory 2 is desirable to be configured to allow simultaneous reading, it is preferable to constitute the line memory with the SRAM. Thus, it is preferable to use a RAM in the LSI such as ASIC, FPGA. The reconstruction unit 3 multiplies data of 11 pixels read out simultaneously×11 lines with 2n-m in order to reconstruct data reduced by the thinning-out processing unit 1.

The selective adding unit 4 masks 11 pixel×11 line data with the halation mask pattern shown in FIG. 7. The halation mask pattern indicates information (range) of surrounding pixels which are affected by reflecting electron. The amount of pixel in a mask region is 0. The selective adding unit 4 adds selectively only an amount of the reflecting electron from surrounding pixels, shielded by the spacer to the attention pixel proximate to the spacer. That is, of pixels proximate to the attention pixel, the pixel data (pixel data obtained by executing reconstruction processing after the thinning-out processing of pixels on an opposite side to the attention pixel across the spacer are added. The spacer position information generating unit 5 judges a positional relationship between the attention pixel and the spacer according to a space distance (SPD) value which is a value indicating the positional relationship between the attention pixel generated from timing control signal received from the timing control unit 13 and the spacer position information.

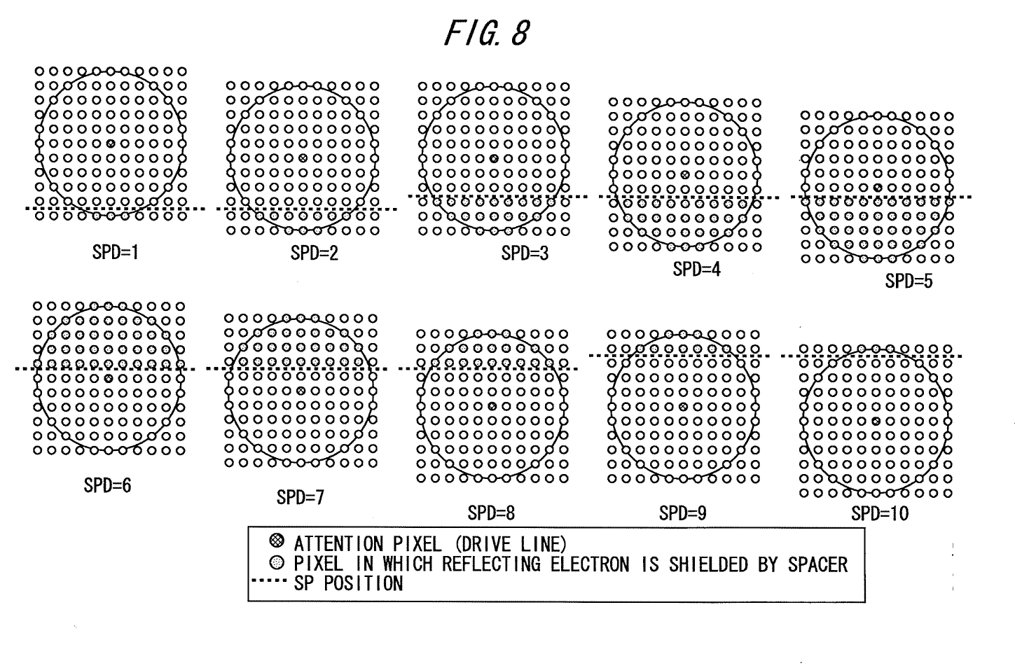

Pixels shielded from reflecting electrons with respect to the attention pixel proximate to a spacer are classified to 10 patterns as shown in FIG. 8. 1-10 SPD values are allocated to each pattern. The total lighting amount relating to shielding can be obtained by selecting pixels represented in gray color corresponding to the SPD value and summing up these pixel values. For pixels not proximate to the spacer, a summing result may be set to 0 because no shielding of reflecting electron by the spacer occurs.

The coefficient multiplying unit 6 multiples the summing result with a coefficient (halation gain value) indicating what percentage of the summing result in the amount of shielded halation. Usually, the coefficient is a value between 0 and 1, and in a panel of this embodiment, it is about 0.03%. A correction value calculated by the coefficient multiplying unit 6 is stored in the second memory 7. The role of the second memory 7 is to adjust timing so that the calculated correction value corresponds to a predetermined pixel position (pixel position corresponding to the calculated correction value) in the original image data (image data which is an objective for correction) received not through the first memory 2. Because according to this embodiment, 1-frame delay is executed, the second memory 7 serves as a frame buffer which stores the correction value. Because the second memory 7 functions as a timing adjusting buffer, it is preferable to use a cheap device like an externally installed DRAM.

A correction value read out from the second memory 7 after one frame is added to original image data Rin, Gin, Bin by the correction arithmetic operation unit 8 as shown in following equations. The adding results are outputted from the correction arithmetic operation unit 8 as the correction data Rout, Gout, Bout.

Rout=Rin+correction value

Gout=Gin+correction value

Bout=Bin+correction value

As described above, according to this embodiment, the correction value is added to the original image data after one frame so as to calculate correction data. However, this deflection by one frame is not a serious problem. The reason is that because images of adjacent frames have a strong correlation, a difference in the correction amount due to a delay by a frame is extremely small. Another reason is that because the correction amount of halation is as small as 0.03% the brightness as described above even in case of image having a weak frame correlation, change in brightness due to correction error is too minute to recognize with the eyes. The image having a weak frame correlation includes, for example, an image in which a white rectangle moves over a black background in each frame.

The above-described halation correction is a method suitable for progressive drive method.

Next, halation correction when the display panel of this embodiment is interlace-driven will be considered. In case of interlace drive, halation light emission particular to that drive method needs to be considered.

In the meantime, the display panel of this embodiment corresponds to both drive methods of progressive drive and interlace drive and the halation correction method can be automatically switched corresponding to a selected drive method.

Basically, the display panel of this embodiment using the surface conduction type emission device is driven (driven line-sequentially) by the unit of a line as described in FIG. 4. A subject of how the human eyes recognize unevenness of halation in this line-sequential drive has bee considered. This inventor repeated experiment on halation correction in the case where the progressive drive was carried out line-sequentially at 60 Hz. The frequency of image display per second is 60 times because the progressive drive is carried out at 60 Hz. As a result of the experiment, assuming that all surrounding reference pixels are lit at the same time as shown in FIGS. 7, 8, it has been found that the halation unevenness (unevenness of brightness which occurs due to uneven generation of the crosstalk within the screen) can be corrected up to a level in which it cannot be recognized by carrying out correction arithmetic operation based on the drive data of surrounding reference pixels. As a result of this, it is apparent that the halation correction arithmetic operation may be carried out by the unit of a frame if the frame rate is around 60 Hz.

Next, a case of display based on an interlace signal will be described. Here, an example that a signal for progressive drive at 60 Hz (hereinafter referred to as “60p drive”) is converted to an interlace signal) and then interlace drive at 120 Hz (hereinafter referred to as “120i drive”) is executed will be described. In case of the interlace drive at 120 Hz, the frequency of image displays per second is 120 times because an image is constituted by the unit of a field although the frame rate (a frame is constituted of two fields, even and odd) is 60 Hz. One of differences between the 120i drive and 60p drive is whether the drive in the unit of field or the drive in the unit of frame. Upon the 120i drive, an amount of two fields (amount of one frame) may be considered to be a reference range according to knowledge about the halation correction upon the 60p drive.

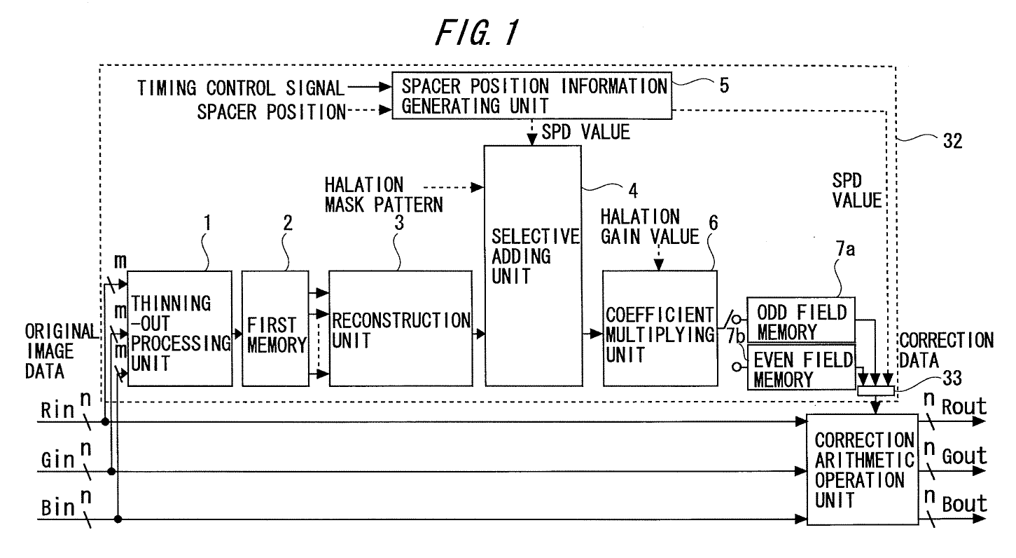

Hereinafter, the halation correction in case of 120i drive will be described with reference to FIG. 1. Description of a portion common to the 60p drive mentioned in FIG. 3 is simplified. The correction value output circuit 32 in FIG. 1 is largely different from the correction value output circuit 31 in including an odd field memory 7a, an event field memory 7b and an arithmetic operation circuit 33. A correction value is outputted from the arithmetic operation circuit 33 and the correction arithmetic operation unit 8 corrects pixel data which is an objective for correction, using the correction value. The thinning-out processing unit 1 carries out a processing of reducing the original data and then transferring to the first memory 2 in the same way as in the case of the 60p drive. An output of the thinning-out processing unit 1 is written into the first memory 2. In this procedure, because an input signal is an interlace signal, signals of lines adjacent vertically are inputted as different field signals. Thus, the data amount processed at the same time by memory is about ½ (amount corresponding to five lines or six liens) as in the case of the progressive drive. Hereinafter, the case of five lines will be described. When data of five lines is stored, data of 11 pixels×5 lines are read out from the first memory 2 for reference for arithmetic operation. The reconstruction unit 3 multiplies data of 11 pixels×11 lines read out at the same time with 2n-m in order to reconstruct the data reduced by the thinning-out processing unit 1.

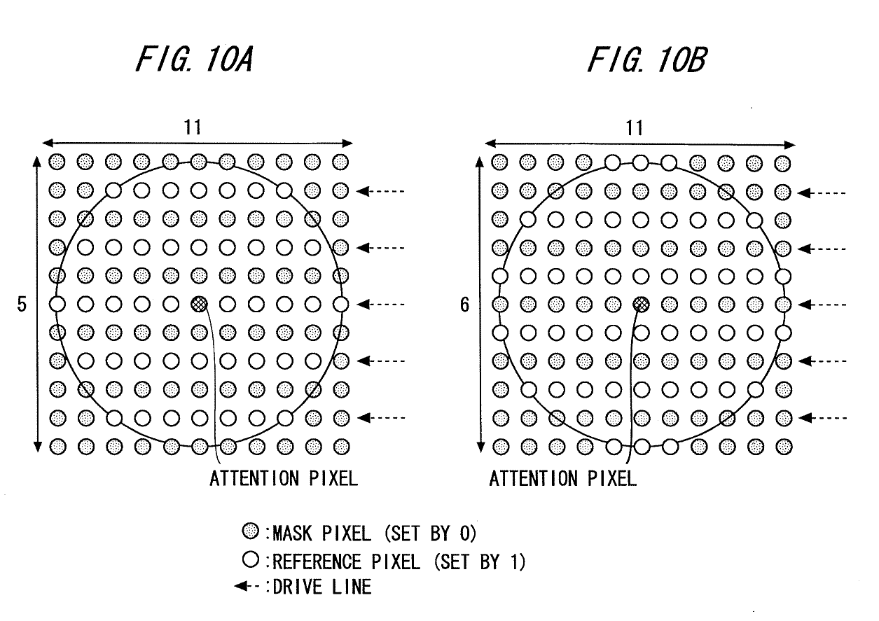

The selective adding unit 4 masks data of 11 pixels×5 lines with a halation mask pattern shown in FIG. 10A. The halation mask pattern of FIG. 10A is a mask pattern applicable to data in a field in which a line containing the attention pixel exits. In the interlace drive, the drive line is different between even field and odd field. Thus, it happens that a line containing the attention pixel is not driven in a field next to the aforementioned field. A halation mask pattern shown in FIG. 10B is applied for data in this field. The reference pixel is data of 11 pixels×6 lines in the field shown in FIG. 10B.

A subsequent processing is the same as correction processing in the above-described progressive drive. That is, the selective adding unit 4 calculates an amount of shielding with the spacer based on the SPD value and the coefficient multiplying unit 6 multiplies the summing result with halation gain value so as to calculate a correction value.

A correction value calculated form data of the odd field is stored in the odd field memory 7a and a correction value calculated from data of the even field is stored in the even field memory 7b. The role of this odd field memory 7a and the even field memory 7b exists in adjusting timing with the original data which is an objective for correction in the same way as at the time of the 60p drive as well as storing correction values calculated by the unit of field.

Each correction value is read out from the odd field memory 7a and the even field memory 7b with a delay by a field and added to the arithmetic operation circuit 33. A correction value obtained as a result of the addition is outputted from the arithmetic operation circuit 33 to the correction arithmetic operation circuit 8. The correction value is added to the original image data by the correction arithmetic operation unit 8. That is, a correction value calculated from data of k-1 even field are added to the original image data of k odd field (odd field of kth frame).

It is considered that at the time of the interlace drive, both light emission of a field in which a line containing the attention pixel is driven (see FIG. 10A) and light emission of a field in which that line is not driven (see FIG. 10B) affect the brightness of halation of the attention pixel. Thus, if a strict method of taking into account influences of light emission of both the fields is adopted as in this embodiment, the halation correction amount at the time of interlace drive can be calculated with high accuracy.

In this embodiment, data of pixel proximate to the attention pixel is extracted and a correction value is determined based on the extracted data. Further, data of pixel proximate to the attention pixel is extracted from a signal of a subsequent field and the correction value is determined based on the extracted data. High accuracy correction is achieved by determining a correction value for correcting data of the attention pixel based on these both correction values.

In this meantime, it is possible to adopt a structure of generation a progressive signal of a frame from signals of two continuous fields of an interlace signal and generates a correction value using the progressive signal. With this structure, calculation of the correction value at the time of interlace drive and calculation of the correction value at the time of progressive drive can be made identical to each other. However, to adopt that structure, a frame memory for converting the interlace signal to the progressive signal is required thereby increasing the circuit size. In this embodiment, the structure is simplified by generating a correction value of each field and then obtaining a correction value for actual use from correction values generated in each of the two fields.

To enable change-over between correction at the time of progressive drive and correction at the time of interlace drive in this embodiment, a configuration including the halation correcting unit shown in FIG. 3 and the halation correcting unit shown in FIG. 1 independently can be adopted. Further, it is possible to adopt a structure in which part of the correction value output circuit 31 and the correction value output circuit 32 (thinning-out processing unit 1, first memory 2, reconstruction unit 3, selective adding unit 4, spacer position information generating unit 5, coefficient multiplying unit 6) is made common while only other components are provided separately.

### Second Embodiment

The correction method of the first embodiment has such an advantage that the halation correction amount can be calculated strictly and accurately. However, to achieve this correction method, a processing rate twice the processing rate of a field is required in signal processing subsequent to the first memory 2. For example, in case of 120i drive, processing rate of 120 Hz is required (this is processing rate twice 60p drive.)

The second embodiment intends to simplify the processing by calculating influences of light emission in a field (that is, field just before) in which the attention pixel is on non-drive line in an approximation way. A block diagram of the correction value output circuit of this embodiment is the same as in FIG. 1.

More specifically, the selective adding unit 4 and the coefficient multiplying unit 6 calculate only a correction value when the attention pixel is located on the drive line using only the mask pattern of FIG. 10A. For example, only a correction value to a pixel on the odd line is calculated form data of the odd field and only a correction value to a pixel on the even line is calculated from data of the even field. Consequently, it comes that a correction value corresponding to a correcting object pixel is not contained in a correction value (second correction value) calculated from a field just before although the correction value corresponding to the correcting object pixel is contained in a correction value (first correction value) calculated from data of a field before by two. Then, according to this embodiment, a correction value corresponding to an adjacent pixel on a line before by one (or line after by one) a correcting object pixel is selected from the second correction value. That is, a correction value calculated for a corresponding pixel in a field before by two and a correction value calculated for a corresponding adjacent pixel in a field just before are added to the original data of the correcting object pixel. That is, following correction values are used for a correcting object pixel (attention pixel). A correction value calculated for the attention pixel in a field is used as a correction value. A correction value calculated (with a proximate pixel regarded as the attention pixel) for a pixel proximate to the attention pixel (pixel proximate spatially to the attention pixel, preferably adjacent pixel) in a field adjacent timely to the former field is adopted as another correction value. A value obtained by summing up the one correction value with the another correction value is used as a correction value for the attention pixel. Although the another correction value is not a correction value calculated for the attention pixel, using this for a help simplifies the arithmetic operation. As a consequence, a correction value calculated for a field can be used for halation correction for data in two fields, that is, in a subsequent field and a field after by two. Additionally, no correction value needs to be calculated for an attention pixel on the non-drive line. That is, because no correction value needs to be obtained by regarding a pixel not to be driven in a field as an attention pixel based on a signal in the field, the arithmetic operation amount and memory capacity can be suppressed to about ½ as compared with the first embodiment.

Hereinafter, the halation correction of this embodiment will be described with reference to FIG. 1. Description of a common unit to the first embodiment is simplified.

The pixel picking unit 1 executes processing of reducing original data and transferring to the first memory 2. Output from the pixel picking unit 1 is written into the first memory 2. At the time when data of five lines is stored, data of 11 pixels×5 lines are read out from the first memory at the same time for reference of the arithmetic operation. The reconstruction unit 3 multiplies the data of 11 pixels×5 lines read out at the same time with 2 n-m in order to reconstruct the data reduced by the pixel unit 1.

The selective adding unit 4 masks data of 11 pixels×5 lines with a halation mask pattern shown in FIG. 10A. Next, the selective adding unit 4 adds only a portion shielded by the spacer of reflecting electrons from surrounding pixels selectively to the attention pixel proximate to the spacer. The spacer position information generation unit 5 judges positional relationship between the attention pixel and spacer according to a timing control signal received from the timing control unit 13 and the SPD value generated based on the spacer position information.

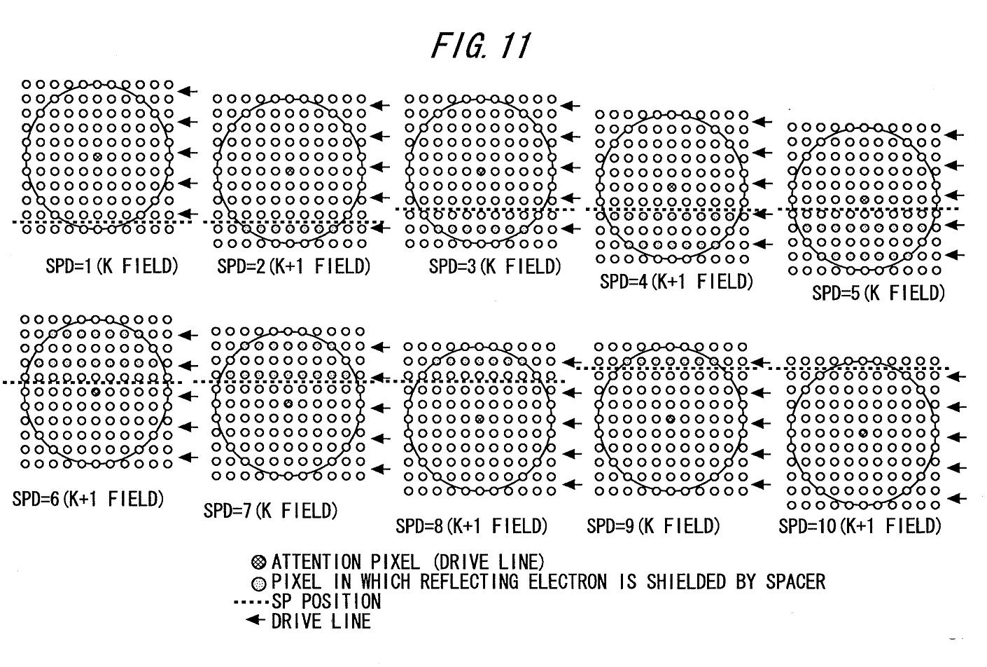

Pixels shielded from reflecting electrons with respect to an attention pixel proximate to the spacer are classified to 10 patterns as shown in FIG. 11 (five patterns for each field). 1-10 SPD values are allocated to each pattern. In the meantime, although FIG. 11 describes SPD1 and SPD10 to facilitate comparison with FIG. 8, the method of this embodiment does not need to take these facts into account. The total lighting amount can be obtained by selecting pixels indicated in gray corresponding to the SPD value and summing up these pixel values. Because pixels not proximate to the spacer induces no shielding of reflecting electrons by the spacer, its summing result may be set to 0.

The coefficient multiplying unit 6 obtains a correction value by multiplying the summing result with a halation gain value. A correction value calculated from the odd field data is stored in the odd field memory 7a and a correction value calculated from even field data is stored in the even field memory 7b respectively.

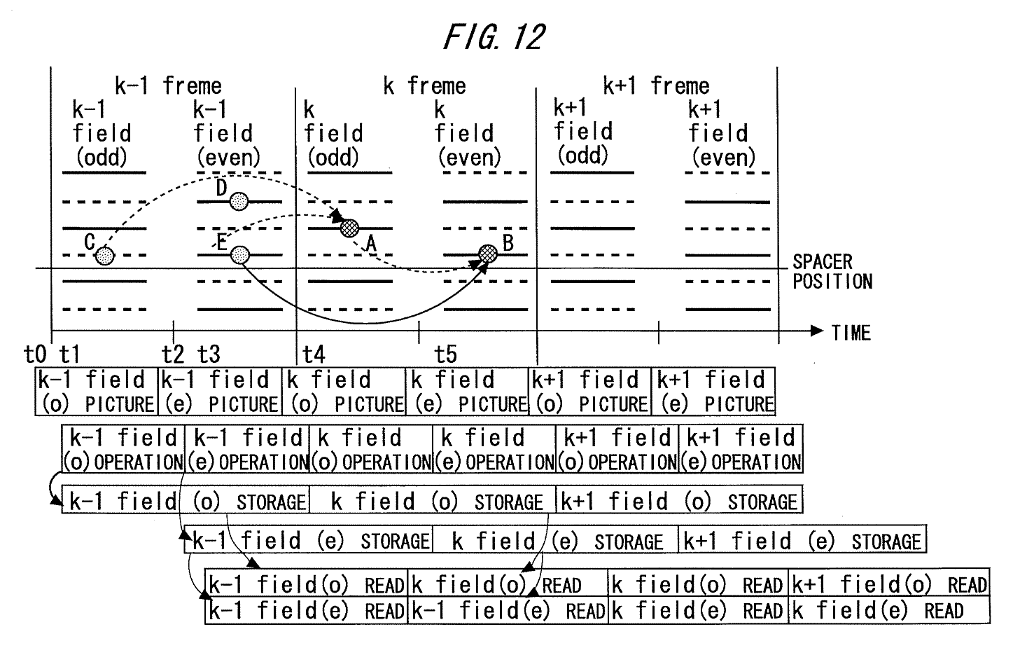

FIG. 12 is a conceptual diagram showing timing of halation correction processing to a correcting object pixel A (SPD=4) in k odd field and a correcting object pixel B (SPD=5 ) in k even field respectively. A solid line indicates a drive line and a dotted line indicates a non-drive line. The abscissa axis indicates time.

At time t0, video data is inputted to k-1 odd field. At time t1, writing data by the amount of five lines to the first memory 2 is completed and arithmetic operation of the correction value based on the k-1 odd field is started. This arithmetic operation result (correction value) is stored into an odd field memory 7a.

At time t2, video data of k-1 even field is inputted. At time t3, write of data of five lines to the first memory 2 is completed and arithmetic operation of the correction value based on data of the k-1 even field is started. This arithmetic operation result (correction value) is stored into the even field memory 7b almost at the same time.

At time t4, video data in k odd field, which is an objective for correction, is inputted. At this time, a correction value based on data is in the k-1 odd field and a correction value based on the k-1 even field are read out from the odd field memory 7a and the even field memory 7b respectively at the same time and transferred to the correction arithmetic operation unit 8. Then, a correction value of corresponding pixel C (SPD=4) in the k-1 odd field and a correction value of adjacent pixel D (SPD=3) in the k-1 even field are added to correcting object pixel A (SPD=4) in the k odd field in the correction arithmetic operation unit 8. Halation correction of the correcting object pixel A is carried out using a correction value obtained as a result of this addition.

The arithmetic operation of the correction value based on data of the k odd field is carried out in parallel to halation correction to data of the k odd field and calculated correction values are stored in the odd field memory 7a successively.

At time t5, video data of the k even field, which is an objective for correction, is inputted. At this time, a correction value based on data of the k-1 even field and a correction value based on data of the k odd field are read out from the even field memory 7b and the odd field memory 7a respectively at the same time and transferred to the correction arithmetic operation unit 8. Then, a correction value of corresponding pixel E (SPD=5) in the k-1 even field and a correction value of adjacent pixel A (SPD=3) in the k odd field are added to correcting object pixel B (SPD=5) in the k even field in the correction arithmetic operation unit 8. Halation correction of the correcting object pixel B is carried out using a correction value obtained as a result of this addition.

The arithmetic operation of the correction value based on data of the k even field is carried out in parallel to halation correction to data of the k even field and calculated correction values are stored in the even field memory 7b successively.

Video data (pixel data) of each field is corrected successively by repeating the above-described processing.

When the spacer is disposed with a positional relationship shown in FIG. 12, the correction arithmetic operation unit 8 reads out the correction values from the odd field memory 7a and the even field memory 7b according to the SPD value of a correcting object pixel. Then, the correction value is added to original data Rin, Gin and Bin of the correcting object pixel and its addition result is outputted as correction data Rout, Gout and Bout.

Rout=Rin+correction value corresponding to SPD value

Gout=Gin+correction value corresponding to SPD value

Bout=Bin+correction value corresponding to SPD value

The above-mentioned correction value corresponding to the SPD value is a sum of correction values of two fields, namely, a field before by two and a field just before as indicated by a next equation. In the next equation, an expression of “SPDx (y even field)” means a “correction value about an attention pixel whose SPD value is x in an even filed of yth frame”.

SPD1 (k even filed)=0

SPD2 (k odd field)=SPD2 (k-1 odd field)+SPD1 (k-1 even field)

SPD3 (k even field)=SPD3 (k-1 even field)+SPD2 (k odd field)

SPD4 (k odd field)=SPD4 (k-1 odd field)+SPD3 (k-1 even field)

SPD5 (k even field)=SPD5 (k-1 even field)+SPD4 (k odd field)

SPD6 (k odd field)=SPD6 (k-1 odd field)+SPD7 (k-1 even field)

SPD7 (k even field)=SPD7 (k-1 even field)+SPD8 (k odd field)

SPD8 (k odd field)=SPD8 (k1 odd field)+SPD9 (k-1 even field)

SPD9 (k even field)=SPD9 (k-1 even field)+SPD10 (k odd field)

SPD10 (k odd field)=0

The above-mentioned correction method of this embodiment can be said to be an approximation method using the height of correlation between video fields.

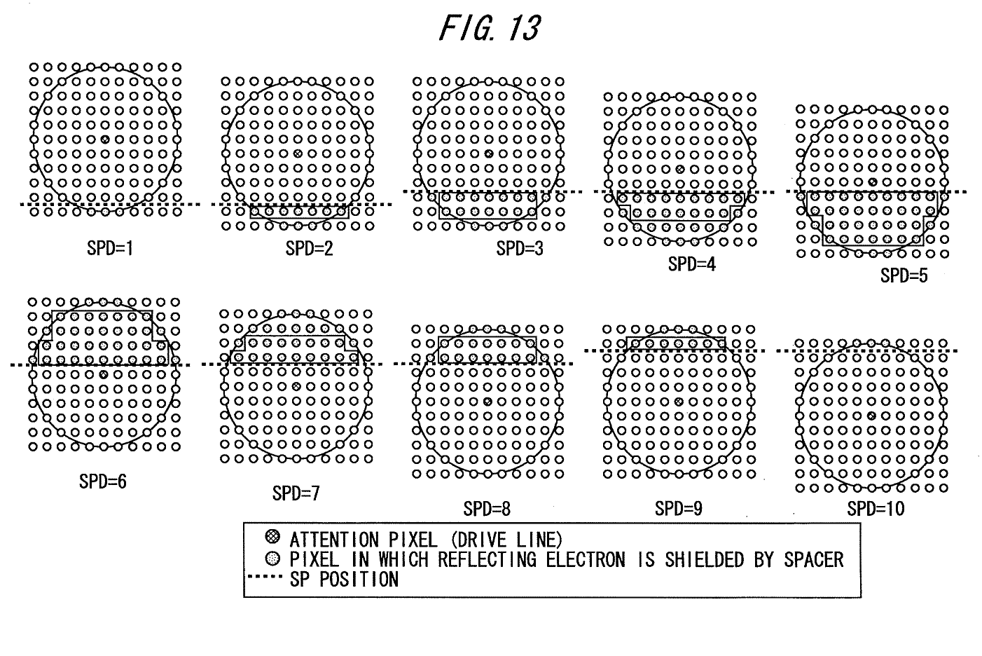

FIG. 13 shows a comparison between the range of the reference pixel at the time of 60p drive described in the first embodiment and the range of the reference pixel at the time of the 120i drive of this embodiment. A unit surrounded by a rectangle is a reference range at the time of 120i drive. According to this Figure, seven pixels not referred exist around a circle and it is considered that this unit becomes a factor which generates an approximation error in the correction method of this embodiment. A degree of influence of the approximation error will be considered here. The amount of halation light emission is expressed as a substantially cylindrical distribution around the luminescent spot when expressed with brightness. However, it is apparent that the amount of halation light emission of an outermost peripheral portion is smaller by 40%-50% than that of a central portion. Thus, approximation without referring to the pixel at the outermost peripheral portion can be acceptable.

That is, when the method of this embodiment is used, the halation correction at the time of interlace drive can be carried out accurately to such an extent that there is not problem in actual use. Further, the processing can be simplified and the circuit size can be reduced as compared with the strict method of the first embodiment, which is advantageous in terms of installation.

### Third Embodiment

In the above embodiments, the method for achieving the halation correction at the time of interlace drive accurately has been described. These methods are different from the method at the time of progressive drive in that two field memories for odd and even are required at the correction arithmetic operation 8. Therefore, when the 60p drive and 120i drive are switched dynamically, sharing of the circuit configuration becomes slightly complicated.

Then, in this embodiment, a method which facilitates sharing of the circuit configuration between the halation correction at the time of progressive drive and halation correction at the time of interlace drive will be described here. The configuration of this embodiment is substantially the same as the configuration shown in FIG. 3 except that an interpolating unit 30 is provided between the first memory 2 and the reconstruction unit 3.

The thinning-out processing unit 1 executes a processing of reducing original data and transferring to the first memory 2. An output from the thinning-out processing unit 1 is written into the first memory 2. The first memory 2 stores 7-line data (amount of line memories necessary for correction at the time of interlace drive described in the second embodiment: 5+amount of reference lines for interpolation arithmetic operation described later). When data of 7 lines is stored, 11 pixels×7 lines are read out at the same time from the first memory 2 for reference for arithmetic operation. Data of 11 pixels×7 lines read out at the same time is referred the interpolating unit 30 which is a conversion circuit.

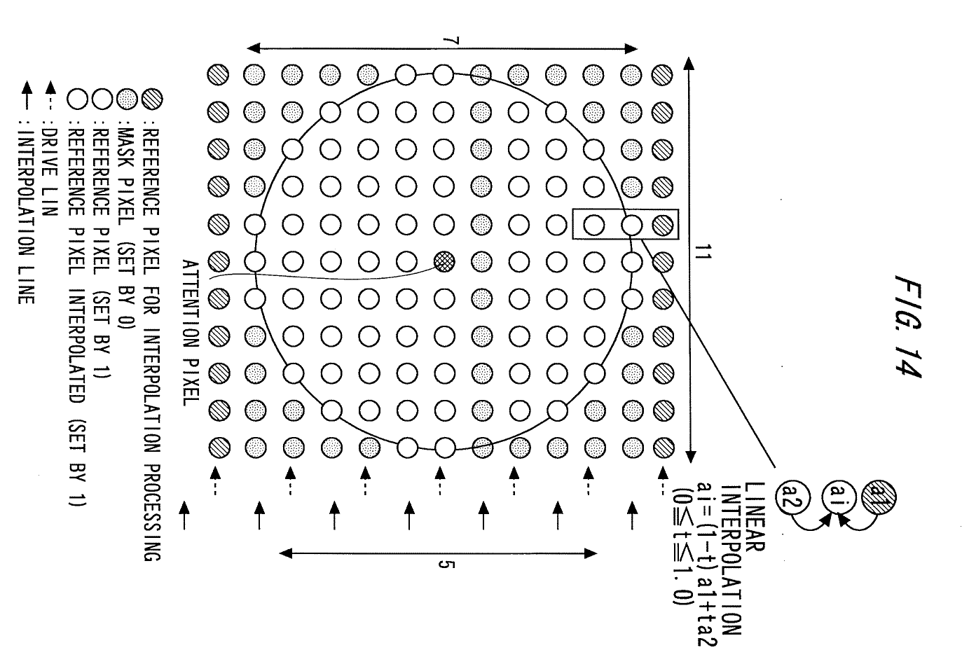

FIG. 14 shows an operation of the interpolating unit 30. The interpolating unit 30 executes interpolation arithmetic operation according to linear interpolation method between lines in order to estimate date of a non-drive line (next line or a line driven in a field just before) from a drive line. Thus, data both at vertically upper and lower fifth lines from an attention pixel needs to be read preliminarily as a reference line for interpolation arithmetic operation.

As an example of the linear interpolation method, an averaging method with an average of pixels (pixels at a position sandwiching a pixel for estimating data) at upper and lower drive lines regarded as an estimated pixel value of pixel of non-drive line can be mentioned. According to the averaging method, a coefficient t in the equation of FIG. 14 is 0.5. Because this interpolation arithmetic operation affects the correction performance of this embodiment, as required, the amount of the reference pixels may be increased, for example, to four pixels vertically of six pixels vertically instead of referring to only two pixels vertically. Further, other interpolation method similar to this method may be applied.

The interpolating unit 30 generates data of 11 pixels×11 lines from data read out from the first memory 2 in the same manner as at the time of 60p drive according to any method described above. That is, signals of 7 lines including signals of 5 lines driven in the field and signals of two lines utilized particularly for interpolation processing are converted to signals of 11 lines. The conversion processing does not need to be carried out in each line. If viewed in the unit of pixel, it can be said that pixel data of 7 lines×11 pixels (pieces) are converted to pixel data of 11 lines×11 pixels (pieces). Increasing the amount of pixel data, which can be referred, enables highly accurate correction. This conversion processing is executed with a signal of a field but does not use signals of other field. Then, the reconstruction unit 3 multiplies data of 11 pixels×11 lines by 2n-m times so as to reconstruct data amount.

Processings of the selective adding unit 4 and coefficient multiplying unit 6 are the same as processing at the time of 60p drive described in the first embodiment. A correction value outputted from the coefficient multiplying unit 6 is stored in the second memory 7. According to this embodiment, the second memory 7 functions as a field buffer in order to achieve 1-field delay. This embodiment is different functionally from the first embodiment in which the second memory 7 functions as a frame buffer and its circuit configuration may be shared. A correction value read out from the second memory 7 after a field is added to original data Rin, Gin, and Bin by the correction arithmetic operation unit 8 as expressed in a next equation. Its arithmetic operation result is outputted from the correction arithmetic operation unit 8 as correction data Rout, Gout, and Bout.

Rout=Rin+correction value

Gout=Gin+correction value

Bout=Bin+correction value

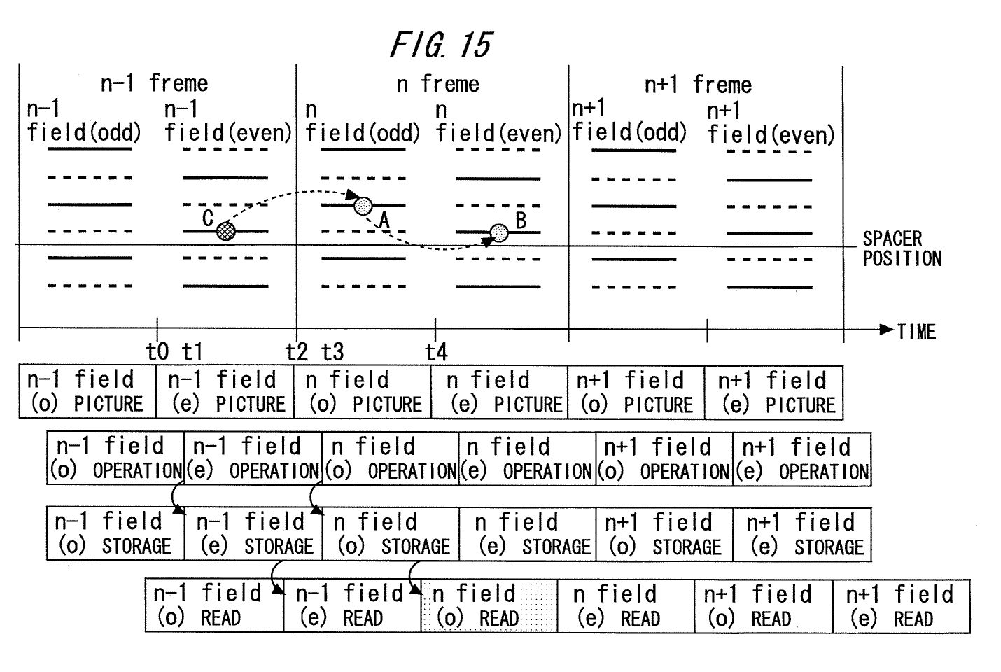

FIG. 15 is a conceptual diagram showing timing of halation correction processing to a correcting object pixel A (SPD=4) in n odd field and a correcting object pixel B (SPD=5) in n even field. The solid line indicates a drive line and the dotted line indicates a non-drive line. The abscissa axis indicates time.

At time t0, video data of n-1 even field is inputted. At time t1, write of data of 7 lines into the first memory 2 is completed and arithmetic operation of the correction value based on data of n-1 even field is started. This arithmetic operation result (correction value) is stored into the second memory 7 substantially at the same time. At time t2, the correction arithmetic operation unit 8 adds a correction value of adjacent pixel C in n-1 even field to a correcting object pixel A in n odd field. As a consequence, halation correction of the correcting object pixel A is achieved.

Likewise, arithmetic operation of the correction value based on data of the n odd field is carried out and at time t4, a correction value of adjacent pixel A of n odd field is added to a correcting object pixel B in n even field. As a consequence, halation correction of the correcting object pixel B is executed.

Video data of each field is corrected successively by repeating the above processing.

As described above, use of the method of this embodiment enables halation correction to be carried out in the interlace drive also according to the same signal processing method as the progressive drive. Thus, if the 60p drive and the 120i drive are switched dynamically, there is such an advantage that the circuit configuration can be shared.

Because when the correction value output circuit shown in FIG. 3 is used at the time of progressive drive, the amount of lines of signal in the interpolating circuit 30 as a conversion circuit does not need to be increased, so that the interpolating circuit 30 controls to output an input signal to a next stage as it is.

### Other Embodiment

The above-described embodiments indicate a configuration for calculating a correction value corresponding to an amount shielded by the spacer of an increase in brightness, which pixels located in the vicinity of a correcting object pixel, can provide to the brightness of the correcting object pixel. The correction value obtained by the arithmetic operation is calculated to the correcting object data so as to increase the correcting object data. As a consequence, the increase in brightness by halation is added falsely to pixels in the vicinity of the spacer as if there is no spacer in the vicinity thereof. As a consequence, the above-mentioned second problem is improved.

On the other hand, this embodiment provides a structure for calculating a correction value corresponding to the increase in brightness which pixels located in the vicinity of the correcting object pixel provide to brightness of the correcting object pixel. Here, the brightness of the correcting object pixel is corrected to be decreased by an amount corresponding to brightness provided to the correcting object pixel by pixels located in the vicinity according to an obtained correction value.

The configuration of the halation correcting unit of this embodiment is the same as the above-described embodiments. However, the operations of the selective adding unit 4 and the correction arithmetic operation unit 8 are different from the above-described embodiments.

If the correcting object pixel is sufficiently apart from the spacer or in the vicinity of the spacer, following controls are carried out.

In the case where it is sufficiently apart from the spacer

Unless there exists a spacer between a pixel (pixel in the vicinity) which can affect a correcting object pixel by halation and the correcting object pixel, an action of shielding halation with the spacer is not effected on the correcting object pixel. Therefore, the selective adding unit 4 integrates data of proximate pixels on the drive line and outputs its result.

Proximate to spacer

Of proximate pixels in the vicinity of the spacer, only data of the proximate pixels on the drive line located on the same side as the correcting object pixel is added.

The correction value is calculated using the integrated value obtained above as in the above embodiment.

Because this embodiment provides a configuration which reduces the increase in brightness by halation by correction, the correction arithmetic operation unit 8 executes processing of reducing the correction value from a correcting object data. This enables display as in a display unit which never generates halation.

In the meantime, as apparent from above, this embodiment can be applied to a structure using no spacer. In a display panel using no spacer or no member equivalent to the spacer, a processing sufficiently apart from the aforementioned spacer may be executed.

Although an example of the display unit using the surface conduction type emission device has been listed here, the crosstalk described as halation in this specification can occur in other display unit. For example in a plasma display unit, plasma generated in a device can affect the brightness of a device proximate to the plasma. In case of a liquid crystal display unit or organic EL display unit, drive voltage provided to a device can affect the drive voltage of a proximate device. In these display units, the crosstalk can be corrected as in the embodiments described in detail. In a transmission type liquid crystal display unit used together with a backlight or projection light source, the light emission region means a region which transmits light. In a reflection type liquid crystal display unit, the light emission region means a region which reflects light.

As a structure for obtaining a correction value for correcting data of the attention pixel based on the interlace signal, a structure intended to obtain the correction value without interpolation processing as in the third embodiment by using only a signal of a field can be provided. However, in a structure which changes over the frequency of image display per second (drive in which the frequency of image display per unit time is differently, as in a drive in which the frequency of image display per second is 120 times and 60 times, a preferred correction value can be obtained by making the content of arithmetic operation for determining the correction value different. That is, there are available a structure for executing arithmetic operation to obtain a correction value for use for correction by adding correction values obtained from plural image data (plural field data in the above first and second embodiments) and a structure for obtaining a correction value by executing arithmetic operation including interpolating arithmetic operation as in the third embodiment. These arithmetic operations have such an effect that if the display frequency of an image is high, an influence of display of plural images is reflected on the correction value.

This application claims the benefit of Japanese Patent Application No. 2005-377893, filed Dec. 28, 2005, and Japanese Patent Application No. 2006-329262, filed Dec. 6, 2006, which are hereby incorporated by reference herein in their entirety.

What is claimed is:

1. An image display apparatus comprising:
a plurality of pixels for displaying an image on a screen; and
a drive unit for outputting a drive signal for driving the plurality of pixels by interlace,
wherein the drive unit includes a correction value outputting circuit for outputting a correction value for correction for suppressing a deterioration of image quality due to crosstalk and an outputting unit for outputting the drive signal corrected by the correction value, and
the correction value is calculated based on pixel data corresponding to at least one pixel proximate to a pixel which is an objective for correction, the pixel data used for the calculation includes pixel data in a field in which the pixel which is an objective for the correction is driven and pixel data in a field in which the pixel which is the objective for the correction is not drive.

2. The image display apparatus according to claim 1, wherein the correction value outputting circuit executes arithmetic operation using a value calculated using the pixel data in the filed in which the pixel which is the objective for the correction is driven and a value calculated using the pixel data in the field in which the pixel which is the objective for the correction is not driven, so as to calculate the correction value.

3. An image display apparatus comprising:
a plurality of pixels for displaying an image on a screen; and
a drive unit for outputting a drive signal for driving the plurality of pixels by interlace,
wherein the drive unit includes a correction value outputting circuit for outputting a correction value for correction for suppressing a deterioration of image quality due to crosstalk and an outputting unit for outputting the drive signal corrected by the correction value,
the correction value outputting circuit includes a memory for storing n pixel data corresponding to n pixels proximate to the pixel which is an objective for correction and a conversion circuit for converting n pixel data stored in the memory to m (m is an integer number larger than n) pixel data, and
the correction value is generated based on an output of the conversion circuit.

4. The image display apparatus according to claim 3, wherein the conversion circuit executes interpolating arithmetic operation using the pixel data corresponding to a plurality of pixels in the n pixels.

5. An image display apparatus comprising:
a plurality of pixels for displaying an image on a screen; and
a drive unit for outputting a drive signal for driving the plurality of pixels by interlace,
wherein the drive unit includes a correction value outputting circuit for outputting a correction value for correction for suppressing a deterioration of image quality due to crosstalk and an outputting unit for outputting the drive signal corrected by the correction value,
the correction value outputting circuit generates the correction value by arithmetic operation using pixel data corresponding to a pixel proximate to a pixel which is objective for correction and executes a first arithmetic operation when frequency of image displays per a unit time by the plural pixels is a first value and a second arithmetic operation different from the first arithmetic operation when frequency of image displays per a unit time by the plural pixels is a second value larger than the first value.

6. The image display apparatus according to claim 1, wherein the correction value is a correction value which increases brightness of pixel in a predetermined region if pixel data corresponding to the plurality of pixels within the screen are identical and crosstalk between pixels proximate to each other in the predetermined region in the screen is lower than a crosstalk between pixels proximate to each other region in the screen.

7. The image display apparatus according to claim 3, wherein the correction value has a value which increases brightness of pixel in a predetermined region if pixel data corresponding to a plurality of pixels within a screen are identical and crosstalk between pixels proximate to each other in the predetermined region in the screen is lower than crosstalk between pixels proximate to each other in other region in the screen.

8. The image display apparatus according to claim 1, wherein the pixel has an electron emitting device and a light emitting region which emits light when irradiated with electron emitted from the electron emitting device, the image display apparatus further comprising a spacer which maintains space between the electron emitting device and the light emitting region, the spacer suppressing crosstalk between pixels proximate to each other.

9. The image display apparatus according to claim 3, wherein the pixel has an electron emitting device and a light emitting region which emits light when irradiated with electron emitted from the electron emitting device, the image display apparatus further comprising a spacer which maintains space between the electron emitting device and the light emitting region, the spacer suppressing crosstalk between pixels proximate to each other.

10. The image display apparatus according to claim 7, wherein the correction value is calculated using pixel data corresponding to a pixel located on an opposite side to the pixel which is objective for the correction with respect to the spacer.

11. The image display apparatus according to claim 1, wherein the correction value is a correction value for correction to reduce the light quantity of the pixel which is increased by the crosstalk.

12. The image display apparatus according to claim 3, wherein the correction value is a correction value for correction to reduce the light quantity of the pixel which is increased by the crosstalk.
